(19) United States
(12) Patent Application Publication
(10) Pub. No.: US 2023/0260407 A1
(43) Pub. Date: Aug. 17, 2023

(54) FLIGHT MANAGEMENT DEVICE AND FLIGHT MANAGEMENT METHOD

(71) Applicant: KDDI CORPORATION, Tokyo (JP)

(72) Inventor: Sou YAMAZAKI, Tokyo (JP)

(73) Assignee: KDDI CORPORATION, Tokyo (JP)

(21) Appl. No.: 18/105,406

(22) Filed: Feb. 3, 2023

(30) Foreign Application Priority Data
Feb. 14, 2022 (JP) 2022-020209

(51) Int. Cl. G08G 5/00

(52) U.S. Cl. CPC G08G 5/0039; G08G 5/0013

(57) ABSTRACT

A flight management device includes: a reception unit which receives flight schedule information including a flight range, flight date and time, and radio communication information; a determination unit which determines whether or not a relationship between the flight range and the flight date and time of a first flight vehicle, and the flight range and the flight date and time of a second flight vehicle becomes a predetermined positional relationship defined to determine whether or not flight vehicles are approaching each other; and a transmission unit which transmits to a radio wave use application device, on condition that the determination unit has determined the first flight vehicle as not approaching the second flight vehicle, radio wave use application information which is application information and includes the flight range, the flight date and time, and the radio communication information of the first flight vehicle.

### CROSS REFERENCE TO RELATED APPLICATION

Priority is claimed on Japanese Patent Application No. 2022-020209, filed Feb. 14, 2022, the content of which is incorporated herein by reference.

### BACKGROUND OF THE INVENTION

### Field of the Invention

The present invention relates to a flight management device and a flight management method for managing information relating to flight of flight vehicles.

### Description of Related Art

Patent Document 1 (International Publication No. 2018/198313) discloses a system that accepts inputs of an area in which a flight vehicle such as drone is flown and a flight purpose, creates a flight path according to the area and the purpose accepted, and controls flight of a flight device according to the flight path created.

### SUMMARY OF THE INVENTION

Therefore, an exemplary object of the present invention is to prevent applications for flying flight vehicles from becoming wasteful.

A flight management device of a first exemplary aspect of the present invention includes: a reception unit which receives flight schedule information including a flight range which indicates at least one of a flight route and a flight area on and in which a flight vehicle is scheduled to fly, flight date and time on and at which the flight vehicle is scheduled to fly, and radio communication information related to radio communication performed by the flight vehicle during flight; a determination unit which determines whether or not a relationship between the flight range and the flight date and time included in the flight schedule information of a first flight vehicle, and the flight range and the flight date and time included in the flight schedule information of a second flight vehicle becomes a predetermined positional relationship defined to determine whether or not flight vehicles are approaching each other during flight; and a transmission unit which transmits to a radio wave use application device, on condition that the determination unit has determined the first flight vehicle as not approaching the second flight vehicle during flight, radio wave use application information which is application information for applying for use of radio waves for the radio communication and includes the flight range, the flight date and time, and the radio communication information included in the flight schedule information of the first flight vehicle.

The transmission unit may transmit to an information terminal associated with the first flight vehicle information indicating at least one of whether or not the determination unit has determined the first flight vehicle as not approaching the second flight vehicle during flight and whether or not the radio wave use application device has permitted the use of radio waves.

The transmission unit may transmit to an information terminal associated with the first flight vehicle, on condition that the determination unit has determined the first flight vehicle as approaching the second flight vehicle during flight, alternative flight schedule information generated by changing at least one of the flight range and the flight date and time in the flight schedule information.

The transmission unit may transmit to an information terminal associated with the first flight vehicle, on condition that use of radio waves has not been permitted by the radio wave use application device, alternative flight schedule information generated by changing at least one of the flight range and the flight date and time in the flight schedule information.

The flight schedule information may further include information indicating that a flight mode of the flight vehicle is applicable to a predetermined flight requirement, and the transmission unit may transmit to a flight application device different from the radio wave use application device, on condition that the determination unit determines the first flight vehicle as not approaching the second flight vehicle during flight and also on condition that a flight mode of the flight vehicle is applicable to the flight requirement, flight application information which is application information for applying for a flight applicable to the flight requirement and includes the flight range, the flight date and time, and the flight requirement included in the flight schedule information of the first flight vehicle.

The transmission unit may transmit the flight application information to the flight application device before transmitting the radio wave use application information to the radio wave use application device, on condition that the determination unit has determined the first flight vehicle as not approaching the second flight vehicle during flight, and the transmission unit may transmit the radio wave use application information to the radio wave use application device, on condition that the flight application device has permitted a flight.

The transmission unit may transmit the radio wave use application information to the radio wave use application device and may transmit the flight application information to the flight application device, on condition that the determination unit has determined the first flight vehicle as not approaching the second flight vehicle during flight, and the transmission unit may, on condition that one of the radio wave use application device and the flight application device has not granted permission, transmit information for canceling the radio wave use application information or the flight application information to the other of the radio wave use application device and the flight application device.

The reception unit may receive the flight schedule information including additional information associated with the flight requirement, and the transmission unit may transmit the flight application information including the additional information to the flight application device.

The transmission unit may transmit notification information including at least part of the flight schedule information to a device associated with a predetermined organization, on condition of being permitted by all devices, including the radio wave use application device, to which application information has been transmitted.

The transmission unit may transmit the notification information to a device associated with an organization managing manned flight vehicles, on condition of being permitted by all devices, including the radio wave use application device, to which application information has been transmitted and also on condition that a flight mode of the flight vehicle is applicable to flight beyond visual line of sight.

The transmission unit may transmit to the flight vehicle flight information for flying the flight vehicle within the flight range on and at the flight date and time, on condition of being permitted by all devices, including the radio wave use application device, to which application information has been transmitted.

A flight management method of a second exemplary aspect of the present invention includes: receiving flight schedule information including a flight range which indicates at least one of a flight route and a flight area on and in which a flight vehicle is scheduled to fly, flight date and time on and at which the flight vehicle is scheduled to fly, and radio communication information related to radio communication performed by the flight vehicle during flight; determining whether or not a relationship between the flight range and the flight date and time included in the flight schedule information of a first flight vehicle, and the flight range and the flight date and time included in the flight schedule information of a second flight vehicle becomes a predetermined positional relationship defined to determine whether or not flight vehicles are approaching each other during flight; and transmitting to a radio wave use application device, on condition that the determination unit has determined the first flight vehicle as not approaching the second flight vehicle during flight, radio wave use application information which is application information for applying for use of radio waves for the radio communication and includes the flight range, the flight date and time, and the radio communication information included in the flight schedule information of the first flight vehicle.

### BRIEF DESCRIPTION OF THE DRAWINGS

FIG. 1 is a schematic diagram of a flight management system according to an exemplary embodiment.

FIG. 2 is a block diagram of the flight management system according to the exemplary embodiment.

FIG. 3 is a schematic diagram for describing flight schedule information.

FIG. 4 is a schematic diagram of a screen for an information terminal to accept input of flight schedule information.

FIG. 5A is a first schematic diagram for describing a positional relationship defined for determining whether or not flight vehicles approach each other during flight.

FIG. SB is a second schematic diagram for describing a positional relationship defined for determining whether or not flight vehicles approach each other during flight.

FIG. 6 is a schematic diagram for describing radio wave use application information.

FIG. 7 is a schematic diagram for describing flight application information.

FIG. 8A is a schematic diagram for describing notification information.

FIG. 8B is a schematic diagram for describing flight information.

FIG. 9 is a diagram showing a flowchart of a flight management method executed by a flight management device.

### DETAILED DESCRIPTION OF THE INVENTION

### [Overview of Flight Management System S]

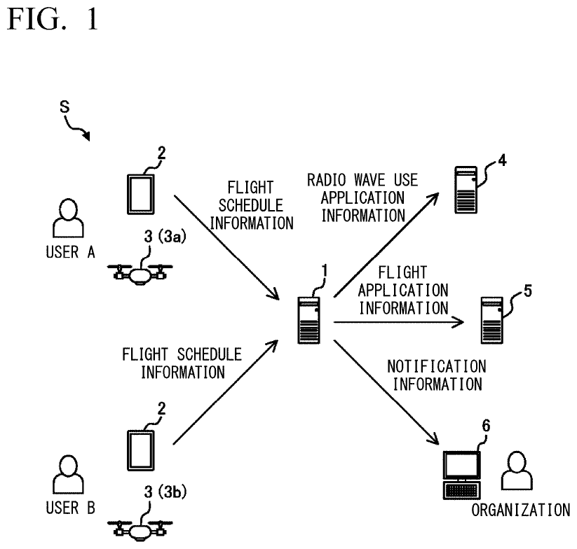

FIG. 1 is a schematic diagram of a flight management system S according to the present exemplary embodiment. The flight management system S includes a flight management device 1, an information terminal 2, a flight vehicle 3, a radio wave use application device 4, a flight application device 5, and an organization device 6. The flight management system S may include a plurality of information terminals 2 and a plurality of flight vehicles 3.

The flight management device 1, the radio wave use application device 4, the flight application device 5, and the organization device 6 are each a single device or a plurality of devices.

Moreover, the flight management device 1, the radio wave use application device 4, the flight application device 5, and the organization device 6 may each be one or more virtual servers operating on a cloud that is a collection of computer resources. The flight management system S may include other terminals, devices, and so forth.

The flight management device 1 is a computer that manages information related to flight of the flight vehicles 3. The flight management device 1 receives flight schedule information of the flight vehicles 3 from the information terminals 2, and transmits predetermined information to the radio wave use application device 4, the flight application device 5, and the organization device 6, based on the flight schedule information received. Further, the flight management device 1 may transmit to the flight vehicles 3 flight information for flying the flight vehicles 3.

The information terminals 2 are each a computer used by a user to input flight schedule information for the flight vehicles 3.

The flight schedule information includes, for example, a flight range in which the flight vehicle 3 is scheduled to fly, flight date and time on and at which the flight vehicle 3 is scheduled to fly, radio communication information related to radio communication performed by the flight vehicle 3 during flight, and flight requirement information indicating that the flight mode of the flight vehicle 3 is applicable to a predetermined flight requirement. The predetermined flight requirement includes, for example, flight in an air exclusion zone, flight at night, flight beyond visual line of sight, and so forth.

The information terminal 2 is, for example, a smart phone, a tablet terminal, a personal computer, or the like. The user is, for example, a person who pilots, manages, or owns the flight vehicle 3.

The information terminal 2 has a display unit such as a liquid crystal display for displaying information received from the flight management device 1, and an operation unit such as a touch panel for accepting user operations. The information terminal 2 transmits and receives information to and from the flight management device 1 through radio communication or wired communication.

The flight vehicle 3 is a device that flies within a flight range designated by the user. The flight vehicle 3 autonomously flies within the flight range, or flies within the flight range according to the user's operation on the information terminal 2. The flight vehicle 3 is, for example, an unmanned flying device such as a drone. The flight vehicle 3 transmits and receives information to and from the flight management device 1 through radio communication.

The radio wave use application device 4 is a computer that accepts a radio wave use application for radio communication performed by the flight vehicle 3 during flight. The radio wave use application device 4 receives application information for applying for radio wave use from the flight management device 1, and transmits to the flight management device 1 a determination result as to whether or not to permit radio wave use based on the received application information. The radio wave use application device 4 transmits and receives information to and from the flight management device 1 through radio communication or wired communication.

The flight application device 5 is a computer that accepts an application for the flight vehicle 3 to fly in a flight mode applicable to a predetermined flight requirement. The flight application device 5 receives from the flight management device 1 application information for applying for flight applicable to the predetermined flight requirement, and transmits to the flight management device 1 a determination result as to whether or not to permit flight based on the received application information. The flight application device 5 transmits and receives information to and from the flight management device 1 through radio communication or wired communication.

The flight management system S is not limited to the radio wave use application device 4 and the flight application device 5, and may include another device as a transmission destination of application information related to the flight of the flight vehicle 3.

The organization device 6 is a computer associated with a predetermined organization, for displaying notification information related to the flight of the flight vehicle 3. The organization is, for example, a manned vehicle organization that manages manned aircrafts such as helicopters. The organization device 6 has a display unit such as a liquid crystal display for displaying information received from the flight management device 1. The organization device 6 transmits and receives information to and from the flight management device 1 through radio communication or wired communication.

An overview of the processing executed by the flight management system S according to the present exemplary embodiment will be described below. Based on the user's operation, the information terminal 2 accepts input of flight schedule information including a flight range, flight date and time, radio communication information, and flight requirement information, and transmits the flight schedule information to the flight management device 1. The flight management device 1 receives flight schedule information of a plurality of flight vehicles 3 from one or more information terminals 2, and stores the flight schedule information in a storage unit.

The flight management device 1 determines whether or not a first flight vehicle 3a approaches a second flight vehicle 3b during flight, based on the relationship between the flight range and the flight date and time included in the flight schedule information of the first flight vehicle 3a among the plurality of flight vehicles 3 and the flight range and the flight date and time included in the flight schedule information of the second flight vehicle 3b among the plurality of flight vehicles 3.

On condition that the first flight vehicle 3a has been determined as not approaching the second flight vehicle 3b during flight, the flight management device 1 transmits to the radio wave use application device 4 radio wave use application information for applying for radio wave use of the first flight vehicle 3a. Based on the radio wave use application information received from the flight management device 1, the radio wave use application device 4 transmits to the flight management device 1 the determination result as to whether or not to permit radio wave use.

Moreover, on condition that the first flight vehicle 3a has been determined as not approaching the second flight vehicle 3b during flight, the flight management device 1 transmits to the flight application device 5 flight application information for applying for flight applicable to a predetermined flight requirement. Based on the flight application information received from the flight management device 1, the flight application device 5 transmits to the flight management device 1 the determination result as to whether or not to permit flight applicable to the predetermined flight requirement.

Furthermore, on condition of being permitted by all devices to which application information has been transmitted, the flight management device 1 transmits notification information including at least part of the flight schedule information to the organization device 6. The organization device 6 displays on the display unit the notification information received from the flight management device 1.

With such a configuration, on condition that the first flight vehicle 3a has been determined as not approaching the second flight vehicle 3b during flight based on the flight schedule information, the flight management system S transmits to each application destination device application information for flying the first flight vehicle 3a. Therefore, the flight management system S can reduce situations where it is found that the flight vehicle 3 cannot fly after an application is made, thereby preventing application for flying the flight vehicle 3 from becoming wasteful.

[Configuration of Flight Management System S]

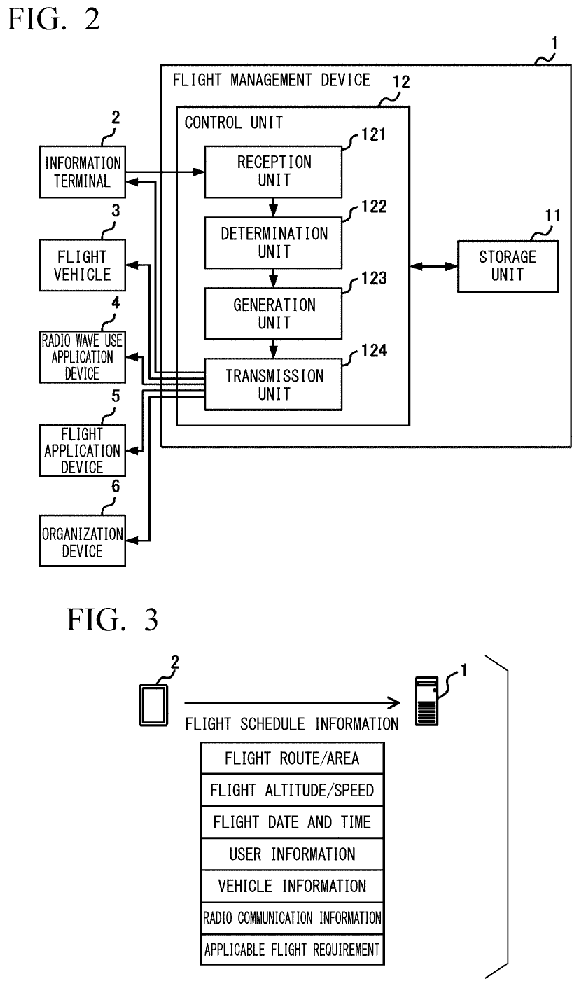

FIG. 2 is a block diagram of the flight management system S according to the present exemplary embodiment. In FIG. 2, arrows indicate main data flows, and there may be data flows other than those shown in FIG. 2. In FIG. 2, each block shows a configuration in units of function rather than in units of hardware (device). Accordingly, the blocks shown in FIG. 2 may be implemented within a single device, or may be implemented separately within multiple devices. Data exchange between the blocks may be performed via any means such as a data bus, a network, or a portable storage medium.

The flight management device 1 has a storage unit 11 and a control unit 12. The storage unit 11 is a storage medium including a ROM (Read Only Memory), a RAM (Random Access Memory), a hard disk drive, or the like. The storage unit 11 preliminarily stores a program executed by the control unit 12. The storage unit 11 may be provided outside the flight management device 1, in which case data may be exchanged with the control unit 12 via a network.

The control unit 12 has a reception unit 121, a determination unit 122, a generation unit 123, and a transmission unit 124. The control unit 12 is a processor such as a CPU (Central Processing Unit), and functions as the reception unit 121, the determination unit 122, the generation unit 123, and the transmission unit 124 by executing the program stored in the storage unit 11.

A configuration for the flight management system S to execute the processing according to the present exemplary embodiment will be described below. Based on a user's operation, the information terminal 2 accepts input of flight schedule information. FIG. 3 is a schematic diagram for describing the flight schedule information.

The flight schedule information includes, for example, the flight range in which the flight vehicle 3 is scheduled to fly, the flight altitude and speed at which the flight vehicle 3 is scheduled to fly, and the flight date and time on and at which the flight vehicle 3 is scheduled to fly. The flight range indicates at least one of the flight route, which is a path along which the flight vehicle 3 is scheduled to fly, and the flight area, which is a region in which the flight vehicle 3 is scheduled to fly. The flight date and time are represented, for example, by the scheduled flight start date and time and the scheduled flight end date and time.

Moreover, the flight schedule information includes, for example, user information about the user who flies the flight vehicle 3, vehicle information related to the vehicle of the flight vehicle 3, and radio communication information related to the radio communication performed by the flight vehicle 3 during flight. The user information includes, for example, identification information such as user ID (Identification) for identifying a user. The vehicle information includes, for example, identification information such as manufacturing number or vehicle ID for identifying the flight vehicle 3, and vehicle type of the flight vehicle 3. The radio communication information includes, for example, the radio wave frequency used by the flight vehicle 3 for radio communication, the type of line used by the flight vehicle 3 for radio communication, and identification information for identifying the communication device included in the flight vehicle 3.

Moreover, the flight schedule information includes, for example, flight requirement information indicating that the flight mode of the flight vehicle 3 is applicable to a predetermined flight requirement. The predetermined flight requirement includes for example flight in an air exclusion zone such as; around an airport, an emergency airspace, an airspace beginning at 150 m, a densely populated area, around a state facility, around a foreign diplomatic establishment, around a defense facility, or around a nuclear facility. Moreover, the predetermined flight requirement may be any one of the following. (1) flight at night, (2) flight beyond visual line of sight, (3) flight at a short distance from buildings, people or vehicles, (4) flight at events, (5) flight involving transportation of dangerous goods, and (6) flight involving dropping goods.

Furthermore, the flight schedule information may include additional information associated with the flight requirement to which the flight mode of the flight vehicle 3 is applicable. The additional information is information additionally needed to apply for flight under the flight requirement to which the flight mode of the flight vehicle 3 is applicable. For example, in a case where the flight mode of the flight vehicle 3 is applicable to the flight requirement, flight in an air exclusion zone, the additional information includes the name of the facility that is a subject of air exclusion zone. For example, in a case where the flight mode of the flight vehicle 3 is applicable to the flight requirement, flight at events, the additional information includes the address of the event venue, the name of the event, and the date and time of the event. For example, information indicating the relationship between flight requirement and additional information is preliminarily stored in the flight management device 1 or the information terminal 2, and the information terminal 2 accepts input of additional information according to the flight requirement input.

The flight schedule information is not limited to the specific information shown here, and may include other information related to the flight of the flight vehicle 3.

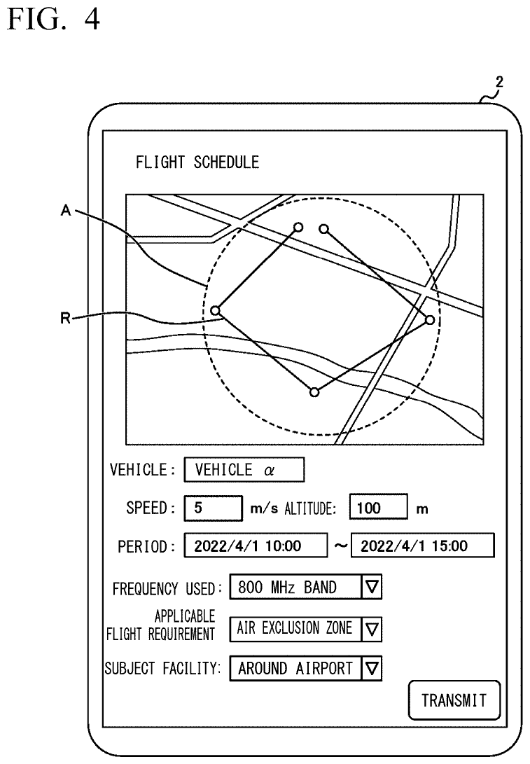

FIG. 4 is a schematic diagram of a screen for the information terminal 2 to accept input of flight schedule information. The information terminal 2, for example, accepts designation of a flight area A, which is a region in which the flight vehicle 3 is scheduled to fly, on the map displayed on the screen. The information terminal 2 accepts designation of a flight route R, which is a path along which the flight vehicle 3 is scheduled to fly in the designated flight area A. The information terminal 2 may accept designation of a three-dimensional flight route R including position and altitude. The information terminal 2 accepts the designated flight area A and flight route R as a flight range. Also, the information terminal 2 may accept only one of the flight area A and the flight route R as a flight range.

Moreover, the information terminal 2 accepts input of the identification information of the flight vehicle 3 (vehicle in FIG. 4), the speed at which the flight vehicle 3 flies, the altitude at which the flight vehicle 3 flies, the flight date and time on and at which the flight vehicle 3 flies (period in FIG. 4), the radio communication information related to radio communication performed by the flight vehicle 3 during flight (frequency used in FIG. 4), the flight requirement information indicating that the flight mode of the flight vehicle 3 is applicable to a predetermined flight requirement, and the additional information associated with the flight requirement to which the flight mode of the flight vehicle 3 is applicable (subject facility in FIG. 4). Also, according to the identification information of the flight vehicle 3 input, the information terminal 2 may automatically decide the speed and radio communication information associated with this identification information.

The information terminal 2 may accept input of only part of the information shown on the screen exemplified in FIG. 4, or may accept input of other information. The information terminal 2 transmits, to the flight management device 1, flight schedule information including each piece of information input on the screen exemplified in FIG. 4.

In the flight management device 1, the reception unit 121 receives flight schedule information of a plurality of flight vehicles 3 from one or more information terminals 2, and stores the flight schedule information in the storage unit 11. Based on the flight schedule information of the plurality of flight vehicles 3, the determination unit 122 determines whether or not the plurality of flight vehicles 3 approach each other during flight. Examples of a state where a plurality of flight vehicles 3 are approaching each other during flight includes: a state where a flight vehicle 3 approaches another flight vehicle 3 within a predetermined distance during flight; wind and vibration caused by a flight vehicle 3 during flight affect another flight vehicle 3; and a flight vehicle 3 collides with another flight vehicle 3 during flight.

The determination unit 122, for example, determines whether or not the relationship between the flight range and the flight date and time included in the flight schedule information of the first flight vehicle 3a and the flight range and the flight date and time included in the flight schedule information of the second flight vehicle 3b becomes a predetermined positional relationship defined to determine whether or not flight vehicles 3 are approaching each other during flight. Among the plurality of flight vehicles 3, the first flight vehicle 3a is the flight vehicle 3 for which an application for flight is to be made. Among the plurality of flight vehicles 3, for example, the second flight vehicle 3b is the flight vehicle 3 for which flight schedule information thereof is stored in the storage unit 11 before the flight schedule information of the first flight vehicle 3a is stored in the storage unit 11. Among the plurality of flight vehicles 3, the second flight vehicle 3b may be, for example, one or each of the plurality of flight vehicles 3 that is different from the first flight vehicle 3a, and for which the flight date and time thereof at least partially overlaps with the flight date and time of the first flight vehicle 3a.

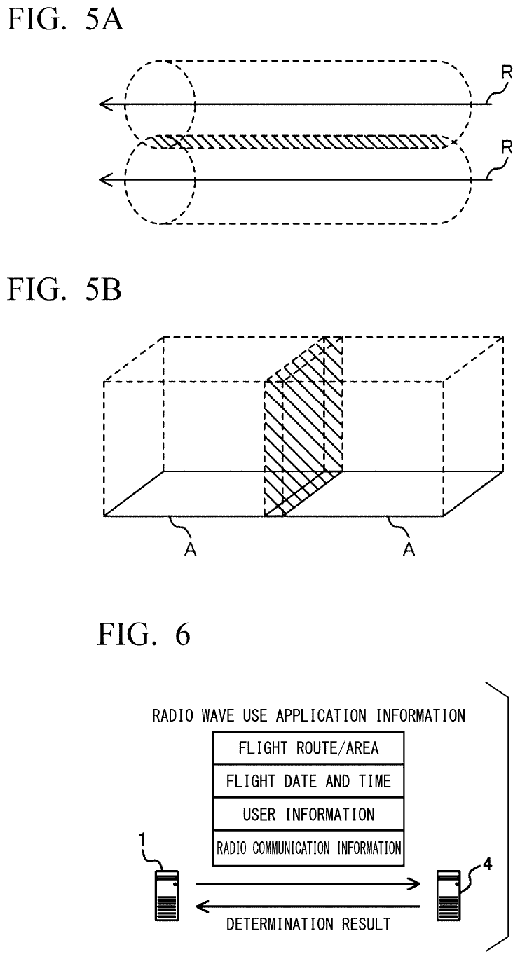

FIG. 5A and FIG. 5B are schematic diagrams for describing a positional relationship defined for determining whether or not the flight vehicles 3 approach each other during flight. In the example of FIG. 5A, if the column-shaped three-dimensional region with the axis thereof serving as the flight route R of the first flight vehicle 3a and the column-shaped three-dimensional region with the axis thereof serving as the flight route R of the second flight vehicle 3b at least partially overlap with each other, the determination unit 122 determines the first flight vehicle 3a as approaching the second flight vehicle 3b during flight, and otherwise determines the first flight vehicle 3a as not approaching the second flight vehicle 3b during flight.

In the example of FIG. 5B, if the cubic three-dimensional region with one plane thereof serving as the flight area A of the first flight vehicle 3a and the cubic three-dimensional region with one plane thereof serving as the flight area A of the second flight vehicle 3b at least partially overlap with each other, the determination unit 122 determines the first flight vehicle 3a as approaching the second flight vehicle 3b during flight, and otherwise determines the first flight vehicle 3a as not approaching the second flight vehicle 3b during flight.

The determination unit 122 is not limited to the specific examples exemplified in FIG. 5A and FIG. 5B, and may determine whether or not the flight vehicles 3 approach each other during flight, based on other criteria. The determination unit 122 may determine whether or not the flight vehicles 3 approach each other during flight, for example, based on whether or not the column-shaped three-dimensional region shown in FIG. 5A and the cubic three-dimensional region shown in FIG. 5B at least partially overlap with each other.

The generation unit 123 generates radio wave use application information for applying for radio wave use for radio communication performed by the first flight vehicle 3a during flight. The generation unit 123 may generate the radio wave use application information on condition that the determination unit 122 has determined the first flight vehicle 3a as not approaching the second flight vehicle 3b during flight, or may generate the radio wave use application information regardless of whether or not the determination unit 122 has determined the first flight vehicle 3a as not approaching the second flight vehicle 3b during flight.

FIG. 6 is a schematic diagram for describing radio wave use application information. The radio wave use application information includes at least part of the flight schedule information, and includes, for example, the flight range, flight date and time, user information, and radio communication information included in the flight schedule information of the first flight vehicle 3a. The radio wave use application information is not limited to the specific information shown here, and may include other information related to the flight of the flight vehicle 3.

On condition that the determination unit 122 has determined the first flight vehicle 3a as not approaching the second flight vehicle 3b during flight, the transmission unit 124 transmits to the radio wave use application device 4 the radio wave use application information generated by the generation unit 123. As a result, the flight management device 1 can reduce situations where the flight vehicle 3 cannot fly after a radio wave use application is made to the radio wave use application device 4, thereby preventing radio wave use applications from becoming wasteful.

The radio wave use application device 4 receives the radio wave use application information transmitted by the flight management device 1. For example, based on the radio wave use application information received from the flight management device 1, the radio wave use application device 4 determines whether or not to permit radio wave use, in accordance with a predetermined criterion. Also, for example, the radio wave use application device 4 may display on the display unit the radio wave use application information received from the flight management device 1, and may accept an input from the user of the radio wave use application device 4 as to whether or not to permit radio wave use

The radio wave use application device 4 transmits to the flight management device 1 the determination result as to whether or not to permit radio wave use. In the flight management device 1, the reception unit 121 receives the determination result transmitted by the radio wave use application device 4.

Furthermore, in a case where flight schedule information includes flight requirement information indicating that the flight mode of the first flight vehicle 3a is applicable to a predetermined flight requirement, the generation unit 123 generates flight application information for applying for flight applicable to this flight requirement. The generation unit 123 may generate the flight application information on condition that the determination unit 122 has determined the first flight vehicle 3a as not approaching the second flight vehicle 3b during flight, or may generate the flight application information regardless of whether or not the determination unit 122 has determined the first flight vehicle 3a as not approaching the second flight vehicle 3b during flight.

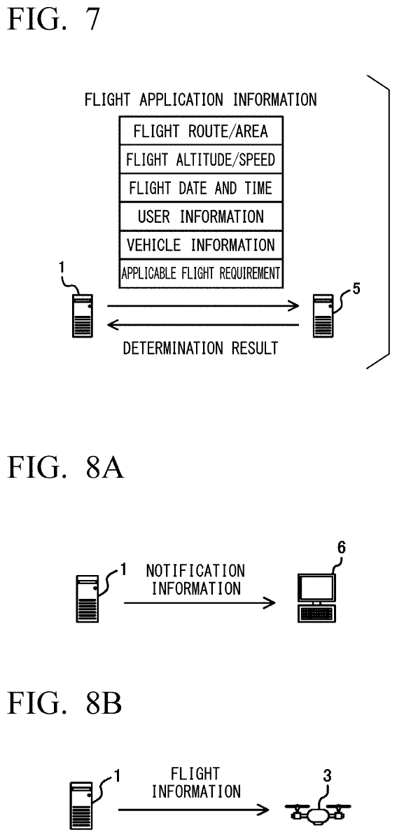

FIG. 7 is a schematic diagram for describing flight application information. The flight application information includes at least part of the flight schedule information, and includes, for example, the flight range, altitude, speed, flight date and time, user information, vehicle information, and flight requirement information included in the flight schedule information of the first flight vehicle 3a. The flight application information may further include additional information associated with the flight requirement to which the flight mode of the flight vehicle 3 is applicable. The flight application information is not limited to the specific information shown here, and may include other information related to the flight of the flight vehicle 3.

On condition that the determination unit 122 has determined the first flight vehicle 3a as not approaching the second flight vehicle 3b during flight and also on condition that the flight schedule information includes flight requirement information indicating that the flight mode of the first flight vehicle 3a is applicable to the predetermined flight requirement, the transmission unit 124 transmits to the flight application device 5 the flight application information generated by the generation unit 123. As a result, the flight management device 1 can reduce situations where the flight vehicle 3 cannot fly after a flight application is made to the flight application device 5, thereby preventing flight applications from becoming wasteful.

The flight application device 5 receives the flight application information transmitted by the flight management device 1. For example, based on the flight application information received from the flight management device 1, the flight application device 5 determines whether or not to permit flight, in accordance with a predetermined criterion. Also, for example, the flight application device 5 may display on the display unit the flight application information received from the flight management device 1, and may accept an input from the user of the flight application device 5 as to whether or not to permit flight.

The flight application device 5 transmits to the flight management device 1 the determination result as to whether or not to permit flight. In the flight management device 1, the reception unit 121 receives the determination result transmitted by the flight application device 5.

The flight management device 1 may make applications to the radio wave use application device 4 and the flight application device 5 in parallel, or may make an application to the radio use application device 4 after having made an application to the flight application device 5. In the case where applications are made to the radio wave use application device 4 and the flight application device 5 in parallel, the transmission unit 124 transmits the radio wave use application information to the radio wave use application device 4 and transmits the flight application information to the flight application device 5, on condition that the determination unit 122 has determined the first flight vehicle 3a as not approaching the second flight vehicle 3b during flight. The reception unit 121 receives the determination results transmitted by the radio wave use application device 4 and the flight application device 5, respectively.

The transmission unit 124, on condition that, in the determination results received by the reception unit 121, one of the radio wave use application device 4 and the flight application device 5 has not permitted radio wave use or flight, transmits information for canceling the radio wave use application information or the flight application information to the other of the radio wave use application device 4 and the flight application device 5. As a result, if not permitted for an application by either the radio wave use application device 4 or the flight application device 5, the flight management device 1 can automatically cancel the application, and it is therefore possible to reduce the time and effort of the user for canceling an application.

In the case where an application is made to the radio wave use application device 4 after an application has been made to the flight application device 5, the transmission unit 124 transmits the flight application information to the flight application device 5 before transmitting the radio wave use application information to the radio wave use application device 4, on condition that the determination unit 122 has determined the first flight vehicle 3a as not approaching the second flight vehicle 3b during flight. The reception unit 121 receives the determination result transmitted by the flight application device 5.

On condition that flight has been permitted by the flight application device 5 in the determination result received by the reception unit 121, the transmission unit 124 transmits radio wave use application information to the radio wave use application device 4. The reception unit 121 receives the determination result transmitted by the radio wave use application device 4. Accordingly, the flight management device 1 makes the radio wave use application to the radio wave use application device 4 on condition that the application is permitted by the flight application device 5, and it is therefore possible to prevent the radio wave use application from becoming wasteful.

In addition to the radio wave use application device 4 and the flight application device 5, the transmission unit 124 may transmit predetermined application information including at least part of flight schedule information to another device. In this case, the reception unit 121 receives determination results respectively from one or more devices to which application information has been transmitted.

Furthermore, the generation unit 123 generates notification information for notifying a predetermined organization of the flight schedule of the first flight vehicle 3a. FIG. 8A is a schematic diagram for describing the notification information. The notification information includes at least part of the flight schedule information, and includes, for example, the flight range, altitude, speed, flight date and time, user information, and vehicle information included in the flight schedule information of the first flight vehicle 3a. The notification information is not limited to the specific information shown here, and may include other information related to the flight of the flight vehicle 3.

The transmission unit 124 transmits the notification information generated by the generation unit 123 to the organization device 6 associated with the predetermined organization, on condition of being permitted by all devices, including the radio wave use application device 4, to which application information has been transmitted (the radio wave use application device 4 and the flight application device 5 of the present exemplary embodiment). In the case where the transmission unit 124 transmits application information to devices other than the radio wave use application device 4 and the flight application device 5, the notification information is transmitted on condition of being permitted in the determination results of all the devices. Accordingly, on condition that applications are permitted by all devices to which application information has been transmitted, the flight management device 1 notifies the organization device 6, and it is therefore possible to prevent the notification from becoming wasteful.

Preferably, on condition of being permitted by all devices, including the radio wave use application device 4, to which application information has been transmitted and also on condition that flight schedule information includes flight requirement information indicating that the flight mode of the first flight vehicle 3a is applicable to flight beyond visual line of sight, the transmission unit 124 transmits notification information to the organization device 6 associated with an organization that manages manned aircraft. As a result, the flight management device 1 can reduce the time and effort of the user for notifying the manned vehicle organization in those cases where it is required to notify the manned vehicle organization that manages manned aircraft such as helicopters when flying the flight vehicles 3 beyond visual line of sight in particular.

Moreover, the generation unit 123 generates flight information for flying the first flight vehicle 3a within the flight range on and at the flight date and time. FIG. 8B is a schematic diagram for describing flight information. The flight information includes information necessary to fly the first flight vehicle 3a, and includes, for example, the flight range, altitude, speed, and flight date and time included in the flight schedule information of the first flight vehicle 3a. The flight information is not limited to the specific information shown here, and may include other information related to the flight of the flight vehicle 3.

The transmission unit 124 transmits the flight information generated by the generation unit 123 to the first flight vehicle 3a, on condition of being permitted by all devices, including the radio wave use application device 4, to which application information has been transmitted (the radio wave use application device 4 and the flight application device 5 of the present exemplary embodiment). In the case where the transmission unit 124 transmits flight information to devices other than the radio wave use application device 4 and the flight application device 5, the flight information is transmitted on condition of being permitted in the determination results of all the devices. Accordingly, on condition that applications are permitted by all devices to which application information has been transmitted, the flight management device 1 transmits the flight information to the flight vehicle 3, and it is therefore possible to prevent the flight information from becoming wasteful.

The transmission unit 124 transmits, to the information terminal 2 associated with the first flight vehicle 3a, result information indicating at least one of whether or not the determination unit 122 has determined the first flight vehicle 3a as not approaching the second flight vehicle 3b during flight, whether or not the radio wave use application device 4 has permitted the use of radio waves, and whether or not the flight application device 5 has permitted the flight. Thereby, the flight management device 1 can notify the user that flies the first flight vehicle 3a of whether or not the first flight vehicle 3a can be flown according to the designated flight schedule information.

[Flow of Flight Management Method]

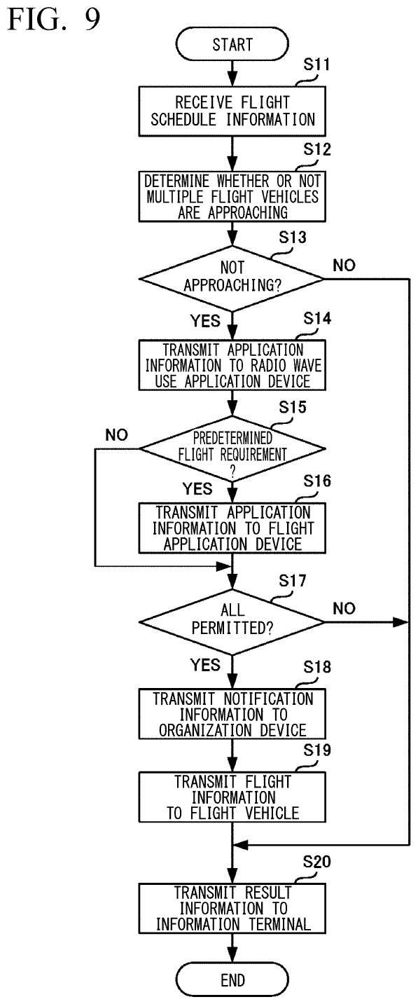

FIG. 9 is a diagram showing a flowchart of a flight management method executed by the flight management device 1. Based on the user's operation, the information terminal 2 accepts input of flight schedule information, and transmits it to the flight management device 1. In the flight management device 1, the reception unit 121 receives flight schedule information of a plurality of flight vehicles 3 from one or more information terminals 2, and stores the flight schedule information in the storage unit 11 (S11).

Based on the flight schedule information of the plurality of flight vehicles 3, the determination unit 122 determines whether or not the plurality of flight vehicles 3 approach each other during flight (S12). The determination unit 122, for example, determines whether or not the relationship between the flight range and the flight date and time included in the flight schedule information of the first flight vehicle 3a and the flight range and the flight date and time included in the flight schedule information of the second flight vehicle 3b becomes a predetermined positional relationship defined to determine whether or not flight vehicles 3 are approaching each other during flight.

If the determination unit 122 determines that the first flight vehicle 3a approaches the second flight vehicle 3b during flight (NO in S13), the flight management device 1 proceeds to Step S20. If the determination unit 122 determines the first flight vehicle 3a as not approaching the second flight vehicle 3b during flight (YES in S13), the transmission unit 124 transmits to the radio wave use application device 4 radio wave use application information that is generated by the generation unit 123 for applying for radio wave use for radio communication performed by the first flight vehicle 3a during flight (S14). The reception unit 121 receives the determination result transmitted by the radio wave use application device 4.

If the flight schedule information does not include flight requirement information indicating that the flight mode of the first flight vehicle 3a is applicable to a predetermined flight requirement (NO in S15), the flight management device 1 proceeds to Step S17. If the flight schedule information includes flight requirement information indicating that the flight mode of the first flight vehicle 3a is applicable to a predetermined flight requirement (YES in S15), the transmission unit 124 transmits to the flight application device 5 flight application information for applying for flight applicable to this flight requirement (S16). The reception unit 121 receives the determination result transmitted by the flight application device 5.

The flight management device 1 may concurrently make the application to the radio wave use application device 4 in Step S14 and the application to the flight application device 5 in Step S15 to Step S16. Moreover, the flight management device 1 may make the application to the radio wave use application device 4 in Step S14 after having made the application to the flight application device 5 in Step S15 to Step S16.

If not permitted by at least some of the devices, including the radio wave use application device 4, to which application information has been transmitted (the radio wave use application device 4 and the flight application device 5 of the present exemplary embodiment) (NO in S17), the flight management device 1 proceeds to Step S20. If permitted by all of the devices, including the radio wave use application device 4, to which application information has been transmitted (YES in S17), the transmission unit 124 transmits the notification information generated by the generation unit 123 for notifying the flight schedule of the first flight vehicle 3a to the organization device 6 associated with the predetermined organization (S18). Also, the transmission unit 124 transmits to the first flight vehicle 3a the flight information generated by the generation unit 123 for flying the first flight vehicle 3a within the flight range on and at the flight date and time (S19).

The transmission unit 124 transmits, to the information terminal 2 associated with the first flight vehicle 3a, result information indicating at least one of whether or not the determination unit 122 has determined the first flight vehicle 3a as not approaching the second flight vehicle 3b during flight, whether or not the radio wave use application device 4 has permitted the use of radio waves, and whether or not the flight application device 5 has permitted the flight (S20).

### Effects of Exemplary Embodiment

In the flight management system S of the present exemplary embodiment, on condition that the first flight vehicle 3a has been determined as not approaching the second flight vehicle 3b during flight based on the flight schedule information, the flight management device 1 transmits the application information for flying the first flight vehicle 3a to the respective devices, including the radio wave use application device 4. Therefore, the flight management system S can reduce situations where the flight vehicle 3 cannot fly after an application is made, thereby preventing application for flying the flight vehicle 3 from becoming wasteful.

### Modified Example

In the present modified example, the flight management device 1 transmits an alternative flight schedule to the information terminal 2 if it is determined that a plurality of flight vehicles 3 will approach each other during flight. Hereunder, differences from the exemplary embodiment described above will be mainly described.

On condition that the determination unit 122 has determined the first flight vehicle 3a as not approaching the second flight vehicle 3b during flight, the generation unit 123 generates alternative flight schedule information by changing at least one of the flight range and the flight date and time in the flight schedule information of the first flight vehicle 3a. Also, on condition that radio wave use has not been permitted by the radio wave use application device 4 in the determination result received by the reception unit 121, the transmission unit 123 may generate the alternative flight schedule information.

The generation unit 123 may, for example, change the altitude of the flight range of the first flight vehicle 3a, so that the flight range of the first flight vehicle 3a after the change will not approach the flight range of the second flight vehicle 3b. Also, the generation unit 123 may, for example, change the flight date and time of the first flight vehicle 3a, so that the flight date and time of the first flight vehicle 3a after the change will not overlap with the flight date and time of the second flight vehicle 3b. The generation unit 123 is not limited to the specific method shown here, and may generate the alternative flight schedule information by another method.

On condition that the determination unit 122 has determined the first flight vehicle 3a as not approaching the second flight vehicle 3b during flight, the transmission unit 124 transmits, to the information terminal 2 associated with the first flight vehicle 3a, the alternative flight schedule information generated by the generation unit 123. The information terminal 2 displays on the display unit the alternative flight schedule information received from the flight management device 1.

As a result, even in a case where the flight schedule information input to the information terminal 2 does not allow the flight vehicle 3 to fly, the flight management device 1 makes it easier for the user to change the flight schedule information and fly the flight vehicle 3.

It should be noted that the present exemplary embodiment enables contribution to the Goal 9 of the United Nations-led Sustainable Development Goals (SDGs), “Build resilient infrastructure, promote sustainable industrialization, and foster innovation”.

As mentioned above, several techniques have been proposed in relation to flight management devices and flight management methods.

In order to control the flight of flight vehicles over a wider area, use of flight vehicles that communicate using predetermined radio waves such as a mobile communication network has been studied. On the other hand, if the number of airborne flight vehicles increases, the amount of communication using the radio waves increases, and there is a risk of affecting communications of mobile phones and the like on the ground. Therefore, it has been considered to limit the number of flight vehicles that fly in a predetermined region at the same time.

This, at least, makes it possible to suppress the influence of the flight of flight vehicles on communication. However, simply limiting the number of flight vehicles cannot ensure safe flight of flight vehicles. Hence there has been a problem that flight of a flight vehicle cannot be permitted unless the flight safety of the flight vehicle is ensured, and the application becomes wasted as a result.

According to at least one exemplary embodiment, for example, there can be achieved an effect of preventing applications for flying flight vehicles from becoming wasteful.

While embodiments of the present invention have been described above, the technical scope of the invention is not limited to the scope described in the foregoing embodiments, and various modifications or changes may be made without departing from the scope and spirit of the present invention. For example, all or part of the device can be functionally or physically distributed or integrated in arbitrary units. Also, a new embodiment resulting from arbitrary combinations of multiple embodiments is also included in the present exemplary embodiment. The effect of the new embodiment arising from the combination also has the effect of the original embodiment.

The processor of the flight management device 1 is an agent of each step (process) included in the flight management method shown in FIG. 9. That is to say, the processor of flight management device 1 executes the flight management method shown in FIG. 9 by executing a program for executing the flight management method shown in FIG. 9. Some of the steps included in the flight management method shown in FIG. 9 may be omitted, the order of steps may be changed, and a plurality of steps may be performed in parallel.

What is claimed is:

1. A flight management device comprising:
a reception unit which receives flight schedule information including a flight range which indicates at least one of a flight route and a flight area on and in which a flight vehicle is scheduled to fly, flight date and time on and at which the flight vehicle is scheduled to fly, and radio communication information related to radio communication performed by the flight vehicle during flight;
a determination unit which determines whether or not a relationship between the flight range and the flight date and time included in the flight schedule information of a first flight vehicle, and the flight range and the flight date and time included in the flight schedule information of a second flight vehicle becomes a predetermined positional relationship defined to determine whether or not flight vehicles are approaching each other during flight; and
a transmission unit which transmits to a radio wave use application device, on condition that the determination unit has determined the first flight vehicle as not approaching the second flight vehicle during flight, radio wave use application information which is application information for applying for use of radio waves for the radio communication and includes the flight range, the flight date and time, and the radio communication information included in the flight schedule information of the first flight vehicle.

2. The flight management device according to claim 1, wherein
the transmission unit transmits, to an information terminal associated with the first flight vehicle, information indicating at least one of whether or not the determination unit has determined the first flight vehicle as not approaching the second flight vehicle during flight and whether or not the radio wave use application device has permitted the use of radio waves.

3. The flight management device according to claim 1, wherein
the transmission unit transmits to an information terminal associated with the first flight vehicle, on condition that the determination unit has determined the first flight vehicle as approaching the second flight vehicle during flight, alternative flight schedule information generated by changing at least one of the flight range and the flight date and time in the flight schedule information.

4. The flight management device according to claim 1, wherein
the transmission unit transmits to an information terminal associated with the first flight vehicle, on condition that use of radio waves has not been permitted by the radio wave use application device, alternative flight schedule information generated by changing at least one of the flight range and the flight date and time in the flight schedule information.

5. The flight management device according to claim 1, wherein
the flight schedule information further includes information indicating that a flight mode of the flight vehicle is applicable to a predetermined flight requirement, and
the transmission unit transmits to a flight application device different from the radio wave use application device, on condition that the determination unit determines the first flight vehicle as not approaching the second flight vehicle during flight and also on condition that a flight mode of the flight vehicle is applicable to the flight requirement, flight application information which is application information for applying for a flight applicable to the flight requirement and includes the flight range, the flight date and time, and the flight requirement included in the flight schedule information of the first flight vehicle.

6. The flight management device according to claim 5, wherein
the transmission unit transmits the flight application information to the flight application device before transmitting the radio wave use application information to the radio wave use application device, on condition that the determination unit has determined the first flight vehicle as not approaching the second flight vehicle during flight, and
the transmission unit transmits the radio wave use application information to the radio wave use application device, on condition that the flight application device has permitted a flight.

7. The flight management device according to claim 5, wherein
the transmission unit transmits the radio wave use application information to the radio wave use application device and transmits the flight application information to the flight application device, on condition that the determination unit has determined the first flight vehicle as not approaching the second flight vehicle during flight, and
the transmission unit, on condition that one of the radio wave use application device and the flight application device has not granted permission, transmits information for canceling the radio wave use application information or the flight application information to the other of the radio wave use application device and the flight application device.

8. The flight management device according to claim 5, wherein
the reception unit receives the flight schedule information including additional information associated with the flight requirement, and
the transmission unit transmits the flight application information including the additional information to the flight application device.

9. The flight management device according to claim 1, wherein
the transmission unit transmits notification information including at least part of the flight schedule information to a device associated with a predetermined organization, on condition of being permitted by all devices, including the radio wave use application device, to which application information has been transmitted.

10. The flight management device according to claim 9, wherein
the transmission unit transmits the notification information to a device associated with an organization managing manned flight vehicles, on condition of being permitted by all devices, including the radio wave use application device, to which application information has been transmitted and also on condition that a flight mode of the flight vehicle is applicable to flight beyond visual line of sight.

11. The flight management device according to claim 1, wherein
the transmission unit transmits to the flight vehicle flight information for flying the flight vehicle within the flight range on and at the flight date and time, on condition of being permitted by all devices, including the radio wave use application device, to which application information has been transmitted.

12. A flight management method executed by a processor, the method comprising:
receiving flight schedule information including a flight range which indicates at least one of a flight route and a flight area on and in which a flight vehicle is scheduled to fly, flight date and time on and at which the flight vehicle is scheduled to fly, and radio communication information related to radio communication performed by the flight vehicle during flight;
determining whether or not a relationship between the flight range and the flight date and time included in the flight schedule information of a first flight vehicle, and the flight range and the flight date and time included in the flight schedule information of a second flight vehicle becomes a predetermined positional relationship defined to determine whether or not flight vehicles are approaching each other during flight; and
transmitting to a radio wave use application device, on condition that the determination unit has determined the first flight vehicle as not approaching the second flight vehicle during flight, radio wave use application information which is application information for applying for use of radio waves for the radio communication and includes the flight range, the flight date and time, and the radio communication information included in the flight schedule information of the first flight vehicle.
